(19) United States
(12) Patent Application Publication
(10) Pub. No.: US 2010/0158237 A1
(43) Pub. Date: Jun. 24, 2010

(54) Method and Apparatus for Monitoring Contact Center Performance

(75) Inventors: Tony McCormack, Galway (IE); John Yoakum, Cary, NC (US); Neil O'Connor, Lackagh (IE); Stephen Whynot, McKinney, TX (US)

Correspondence Address: BARNES & THORNBURG LLP, P.O. BOX 2786, CHICAGO, IL, 60690-2786, US

(73) Assignee: Nortel Networks Limited, St. Laurent (CA)

(21) Appl. No.: 12/339,998

(22) Filed: Dec. 19, 2008

(51) Int. Cl. H04M 3/00

(52) U.S. Cl. 379/265.06

(57) ABSTRACT

A system for monitoring a communication session in a contact center comprises a store of one or more defined speech events which may occur in a communication session for a contact being handled by an agent operating an agent station of the contact center, a speech event comprising at least one occurrence of at least one word in an audio stream of a communication session. A speech analyser is operable, during a communication session involving an agent station of the contact center, to detect the occurrence of one of the speech events. An event generator is responsive to detection of one of the speech events, for issuing an event notification during the communication session identifying the speech event to a reporting component of the contact center which has been configured to receive such event notifications. A display displays event data for contacts being handled by the contact center in real-time at a supervisor station of the contact center, the displayed event data including the speech event identified in the event notification.

### FIELD OF THE INVENTION

The present invention relates to a method and apparatus for monitoring contact center performance.

### BACKGROUND

Contact centers provide for communications between external parties (referred to herein as “customers”) and resources of the contact center.

These contact center resources are most usually human agents who speak with or message interactively with the customer, but can also be automated resources, such as interactive applications which are responsive to voice or keypad inputs or received messages, artificially intelligent agents, and recorded media playback applications.

Referring now to FIG. 1 customers operate client devices 20 which connect through to the contact center via an appropriate gateway 22 typically through a network including the PSTN, Mobile networks, Internet or any combination thereof.

Contacts are typically queued 32 before being connected through at least in some cases to an agent 34 typically operating a network client connected to a contact center server 30 via a contact center local area network (LAN) 36.

The session between a client device 20 and agent device 34 can be controlled as a conference call within a media server 40 associated with the contact center server 30.

One application that can run on such media servers is a call recorder 42 and this can store the entire transcript of any contacts in a database 44 for later analysis, for example in operator training where a contact is played back with a supervisor assessing the performance of the agent handling the contact.

To assist in classifying and indexing the contact information for later retrieval, the recorded call information in the database 44 can be supplemented with other information intrinsic to each contact, for example:
the number dialed by the customer to access the contact center
the media type being used for the contact (e.g. voice, video, instant messaging, SMS (short messaging service) text messages, email, etc.)
the customer's own number, IP address, IM or email address, etc.
stored history and account information relating to the customer
inputs provided by the customer during the contact, such as responses to interactive voice prompts, menu choices navigated after connecting, etc.
the queue used to service the customer.

More recently stand alone speech analysis engines 46 for example, as supplied by Nexidia, see http://www.nexidia.com, have been deployed to identify keywords and combinations of keywords, within call recordings. This assists in data mining of such databases 44 and facilitates retrieval of contact information from the database. Separately, speech analysis engines have also been deployed typically by security forces in monitoring phone conversations so that for example the incidence of certain words or sequences of words within phone conversations or more generally telephony sessions can be identified and notified to authorities who can react accordingly.

Nonetheless, the information stored in an off-line database 44 provides limited information to a supervisor who may be concerned with ensuring that a contact center is operating optimally in real-time. This managing of agent performance, customer service-levels and queue balancing to ensure that optimal use is made of the limited contact center resources is a major problem for contact center managers and the present invention aims to mitigate this problem.

### SUMMARY OF THE INVENTION

According to the present invention there is provided a method and apparatus for monitoring contact center performance.

This invention allows the power of speech analytics to be harnessed in the realtime operation of the call center.

The invention enables the provision of real-time management information systems which provide statistical information to managers representing a massive potential for call center efficiencies and performance optimization.

### BRIEF DESCRIPTION OF THE DRAWINGS

An embodiment of the invention will now be described, by way of example, with reference to the accompanying drawings, in which:

FIG. 1 is a schematic diagram of a conventional contact center system with off-line speech analytics; and

FIG. 2 is a schematic diagram of a system for providing real-time analysis of call center activity according to an embodiment of the present invention; and

FIG. 3 is a block diagram illustrating information stored in the report component of FIG. 2.

### DESCRIPTION OF THE PREFERRED EMBODIMENT

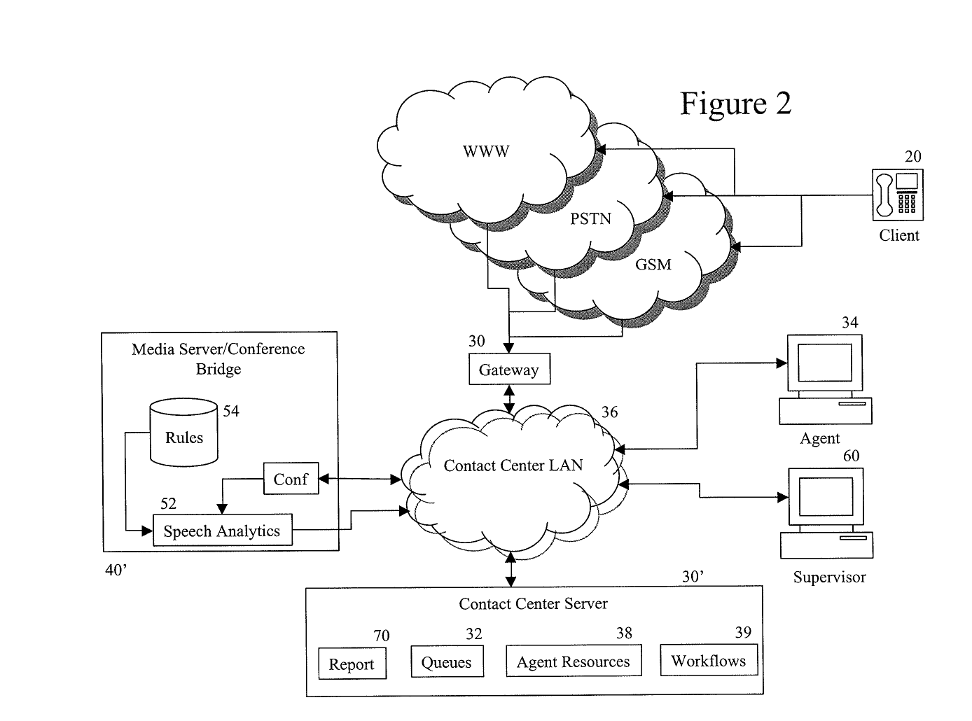

Referring now to FIG. 2 which is a schematic diagram of a contact center according to an embodiment of the invention. The contact center, which may, for example, be a traditional telephony switch or a softswitch or a SIP server has several human agents located at workstations 34. Only one agent workstation 34 is shown but in a contact center there will typically be anything from tens to thousands of such workstations. The agent workstation is provided with software which runs a contact centre agent desktop application. The agent workstation may also be provided with telephony hardware (not shown) which is integrated with the agent desktop application, such that the queue control software running on the contact center server 30′ can “push” a call to the agent workstation, with call details appearing within the agent desktop application.

Inbound contacts arriving at the contact center are controlled by the contact center server 30′ which manages several functions, such as management of queues 32, management of agent resources 38, and workflow control of contacts 39. The physical call is terminated at a media server/conference bridge 40′ while the contact is being queued, and when an appropriate agent such as agent 34 is allocated to the call, that agent's workstation application is placed into a conference with the held call at conference bridge 40′, allowing the agent and customer to speak.

It will be appreciated that where the workstation 34 is suitably equipped, other media types such as video calls, short messaging service (SMS) and multimedia messaging service (MMS) sessions, and email communications can of course also be employed.

In this regard, the communication between contact center entities is conducted in conventional manner over a contact center LAN 36.

As well as inbound calls made by a customer 20 to the contact center, a contact can be part of an outbound campaign. Typically, in this case a script initializes a contact and the agent operates according to a workflow 39. Typically, a workflow presents a series of lines to be spoken by the agent including: an introduction; a number of general questions to the customer with form controls for answers which provide for different branching outcomes according to the response of the customer; and a conclusion. These scripts are supervisor defined to give focus to the call and collect information, for surveys, telemarketing, debt collection etc. for storage and retrieval along with other contact information through a report component 70. Often the answers are multiple choices and entered through the workstation application via radio buttons, check boxes or dropdown lists, but free-form text boxes may also be employed. Normally, the goal is to identify customers who are interested in a product or service or who are willing to provide information or participate in research, and to complete the transaction as quickly and efficiently as possible, with the workflow being tailored to that end.

Generally, significant monitoring is involved by supervisors typically operating workstations 60 within the call center connecting to the report component 70 to determine how effectively resources are being used at any given time in both inbound and outbound contacts.

The present invention improves this monitoring by integrating real-time analysis of speech into contact centers as described in more detail below to alleviate the burden on such supervisors and to improve the manner in which information is provided to such supervisors. Within the media server 40′, a real-time speech analytics engine 52 for example as provided by Nexidia mentioned above is employed in conjunction with a set of rules 54 which categorise various sets of keywords or phrases as something meaningful to the business of the contact center. In one embodiment, the media server 40′ comprises a media application server (MAS) conferencing application for a Nortel SIP Contact Center. Based on configured keyword rules 54, the MAS notifies a contact center reporting component 70 of the occurrence of a match for any of these rules 54 within one or both of the customer or agent audio stream for the contact along with the call ID and other relevant metadata for the contact.

So, for example, rules 54 can be devised which will generate events if contacts being handled by agents or by a support skillset are looking for new product information; or if the calls being handled by agents contain expletives.

The reporting component 70 can then associate statistics related to the occurrence of the rule within the audio stream for the contact with other statistics for the contact, agent, queue, skillset, site etc.

A supervisor application running on the workstation 60 can then be arranged to display the occurrence of this information stored in the reporting component 70 in realtime. This can display information both in terms of current contacts being handled at any given time by the contact center or the events can be stored with contact information pertaining to a session i.e. a shift comprising a number of calls made by an agent, for an agent or with historical information for an even longer period.

Then depending on how information is indexed, information can be displayed by agent, business unit, queue, site etc. both for current calls only or driven in conjunction with historical information from previous contacts.

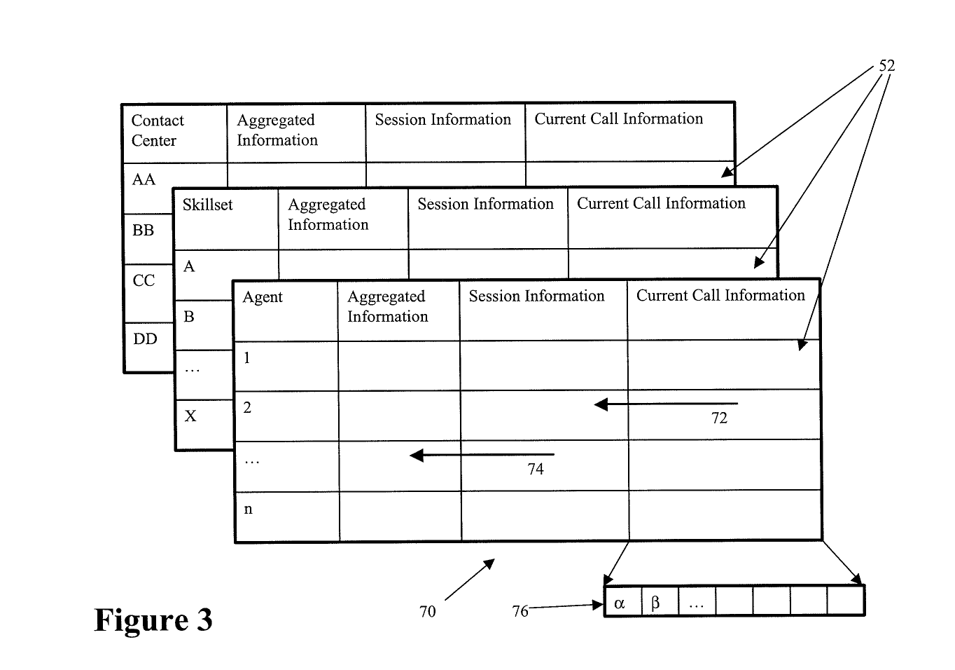

So referring to FIG. 3, events generated for current calls are stored by the reporting component 70 and indexed for retrieval by agent, skillset, or contact center identifier. Once calls are complete, information for the call is aggregated with information for a session as indicated by the line 72. As sessions are completed information for the sessions is aggregated with information for even longer historical periods as indicated by the line 74.

This invention therefore provides a mechanism enabling the display of results of speech analysis alongside the other statistics typically displayed in a contact center supervisor's realtime display.

So, for example, the expanded box 76 shows events α, β . . . which have occurred in a contact being handled by agent n. Corresponding links to these events will be added to the tables the agent n's skillset and for agent n's contact center.

Some of these events will have been generated by the analytics engine 52 whereas others may have been generated through agent interaction with the workstation application during the course of the contact, for example, to indicate the agent's progress through an outbound campaign contact.

Now a supervisor monitoring a site or sites for use of expletives for example, may have set up one or more rules 52 with a view to flagging either when:
agent whisper, i.e. when a supervisor might conference in to a contact and communicate with the agent without the customer being able to hear;
barge-in, where the supervisor is fully conferenced into a contact and may communicate with the customer on behalf of the agent; or
agent monitoring, where the supervisor conferences into the contact for listening only
   might be required.

However, if the rules 54 are poorly or loosely defined, it is possible that such events may be registered too frequently and/or concurrently for too many contacts making it difficult for a supervisor to respond effectively to contacts which may need assistance or to monitor contacts which may not be progressing effectively.

However, with the data produced according to the present invention, a supervisor can more readily view what is happening in real time within their contact center. So, for example, they may be able to see that while they are monitoring one call where an expletive event was generated, several other calls registered this event. This may mean that their rules 54 were defined too loosely and that perhaps the rules may need to be tightened to generate an event only when say several expletives are used within a given period in a call.

On the other hand, if such events were occurring infrequently and perhaps agents began to complain that they were not getting assistance for contacts with difficult customers, the rule 54 might need to be broadened.

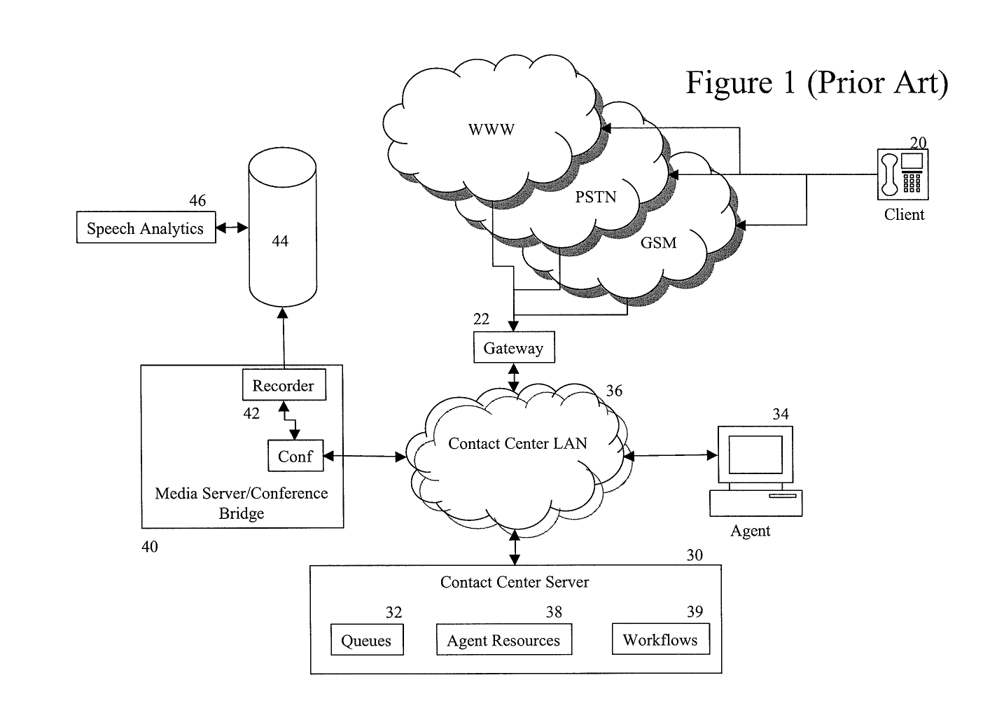

Other uses of the present invention are for example, to use the real-time speech analysis of contacts to determine whether the contact should in fact be recorded. So for example, the occurrence of a given speech event may trigger call recording to a database of the type described in relation to FIG. 1. Supervisors could then choose to monitor the number of calls being recorded in real-time to determine whether the resources being allocated to call recordal were sufficient.

In any case, it will be appreciated that given the multi-dimensional nature of the data being generated as shown in FIG. 3, it could be useful to store the data in a suitably tagged Resource Description Framework (RDF) or Friend of a Friend (FOAF) structure. Then visualization techniques based on this structure can be employed to enable the supervisor 60 the better navigate the data space and to view data of concern to them. So for example, one supervisor may be concerned with monitoring the results of the rules being used to drive agent whisper, barge-in and monitoring; whereas another may be more interested in looking at how various agents with different skillsets may be progressing through their calls by looking at the timing of speech analysis driven events within current calls. Thus, storing the contact data in a suitably structured and tagged form makes it possible for these supervisors to more easily find their required view of the data.

1. A method of monitoring contact center performance, comprising the steps of:
defining one or more speech events which may occur in a communication session for a contact being handled by an agent operating an agent station of said contact center, a speech event comprising at least one occurrence of at least one word in an audio stream of a communication session;
during a communication session involving an agent station of said contact center, analysing said communication session to detect the occurrence of one of said speech events;
upon detection of said one of said speech events, issuing an event notification during said communication session identifying said speech event to a reporting component of the contact center which has been configured to receive such event notifications;
displaying event data for contacts being handled by said contact center in real-time at a supervisor station of said contact center, said displayed event data including said speech event identified in said event notification.

2. A method as claimed in claim 1 wherein said audio stream is one or both of an audio stream for a customer of said contact center or said agent handling said customer.

3. A method as claimed in claim 1, further comprising:
defining one or more non-speech events which may occur in a communication session;
detecting said non-speech events during a communication session; and
providing respective notifications of said non-speech events to said reporting component.

4. A method as claimed in claim 1, comprising: maintaining and analysing said communication session at a conference bridge communicatively coupled to a contact center server; said reporting component receiving said speech event notifications from said conference bridge and making said event notifications available to other contact center services or entities.

5. A method as claimed in claim 1 wherein said displaying comprises displaying event notifications which match respective criteria to a plurality of supervisors of said contact center.

6. A method as claimed in claim 5 wherein said criteria are based on a combination of said speech events for said calls currently being handled by said call center and one or more of: non-speech events for calls currently being handled by said call center; meta-data relating to said contacts; and historical data from contacts handled by said call center.

7. A method as claimed in claim 1, further comprising the step of causing said communications session to be recorded in response to said event notification.

8. A method as claimed in claim 1, further comprising the step of conferencing into said communications session a supervisor in response to said speech event notification.

9. A method as claimed in claim 1, further comprising the step of issuing an alert at a supervisor station in response to said speech event notification.

10. A method as claimed in claim 1, further comprising the step of inputting said speech event notification into a statistical application which maintains real-time statistics relating to a plurality of contact center communications sessions based on said speech event notifications.

11. A computer program product comprising a computer-readable medium encoding instructions which, when executed in a computing system of a contact center, are effective to cause said computing system to:
define one or more speech events which may occur in a communication session for a contact being handled by an agent operating an agent station of said contact center, a speech event comprising at least one occurrence of at least one word in an audio stream of a communication session;
during a communication session involving an agent station of said contact center, analyse said communication session to detect the occurrence of one of said speech events;
upon detection of said one of said speech events, issue an event notification during said communication session identifying said speech event to a reporting component of the contact center which has been configured to receive such event notifications;
display event data for contacts being handled by said contact center in real-time at a supervisor station of said contact center, said displayed event data including said speech event identified in said event notification.

12. A system for monitoring a communication session in a contact center, comprising:
a store comprising one or more defined speech events which may occur in a communication session for a contact being handled by an agent operating an agent station of said contact center, a speech event comprising at least one occurrence of at least one word in an audio stream of a communication session;
a speech analyser operable, during a communication session involving an agent station of said contact center, to detect the occurrence of one of said speech events;
an event generator, responsive to detection of said one of said speech events, for issuing an event notification during said communication session identifying said speech event to a reporting component of the contact center which has been configured to receive such event notifications;
a display for displaying event data for contacts being handled by said contact center in real-time at a supervisor station of said contact center, said displayed event data including said speech event identified in said event notification.
